(19) United States
(12) Patent Application Publication
(10) Pub. No.: US 2005/0022252 A1
(43) Pub. Date: Jan. 27, 2005

(54) System for multimedia recognition, analysis, and indexing, using text, audio, and digital video

(76) Inventor: Tong Shen, New York, NY (US)

Correspondence Address: Law Offices of Albert Wai-kit Chan, LLC, WORLD PLAZA, SUITE 604, 141-07 20TH STREET, WHITESTONE, NY, 11357, US

(21) Appl. No.: 10/161,920

(22) Filed: Jun. 4, 2002

(51) Int. Cl. H04N 7/16; H04N 7/10; H04N 7/025

(52) U.S. Cl. 725/135; 725/136; 715/500.1; 715/501.1; 725/32

(57) ABSTRACT

A new system design of multimedia recognition, processing, and indexing utilizes several new researches and technologies in the field of multi-media processing. The system integrates mature technologies being used in video security surveillance, media post-production, digital video storage and management, military visual and tacking technologies. The system makes unique integration of these existing, new, and upcoming technologies that have not been used in this combined fashion before, therefore providing new usage and applications beyond the simple sum of the functions of each technology. These technologies as components in a system that is open standard, and therefore can improve itself by modifying and replacing the technology components. The design of the system targets primarily heavily produced media contents from news, entertainment, and education and training, but not limited to these contents. Other digital contents, from live broadcast, to web broadcast, to home video, web cam, etc. can certainly use many different components of the system, and to utilize the open standard platform for various usages.

### RELATED APPLICATIONS

This application claims the priority date established by provisional application 60/294,671 filed on Jun. 1, 2001.

### BACKGROUND

INCORPORATION BY REFERENCE Applicant hereby incorporates herein by reference, any and all U.S. patents, U.S. patent applications, and other documents and printed matter cited or referred to in this application.

1. Field of Invention

This invention is in the field of multi-media technology. In particular, it relates to text comparison, optical character recognition, cross-comparative indexing, and digital video processing technology such as screen text recognition, video boundary, color and pattern matching, image recognition, and image tracking. The system is based on an open standard platform; therefore it provides a seamless integration of many technologies, sufficient to handle the needs of media industry, both the traditional media of news and entertainment and new interactive media.

2. Description of Prior Art

As the importance of electronic media grow, both the traditional news and entertainment TV, cable, video/VCR, camcorder, and the new media of internet, interactive TV (enhanced, or on-demand), there is a strong need of a system that will be able to index and retrieve information according to increasingly complex and sophisticated needs of the viewer/user of the media contents. Internet so far is still mainly text based simple still picture and limited animation. Traditionally, several industries have developed and utilized a number of technologies that solve one puzzle or another in making automatic and intelligent understanding of video database possible. Non-Linear post-production, automatic security surveillance, military visual and tracking devices, digital storage content management, just to name a few.

There are also image recognition, color and pattern matching, and tracking algorithm being researched at a number of media labs throughout the world. Moreover, certain mature text and audio processing technologies may also come into play in processing multi-media contents.

So far, none of these efforts managed to provide a solution, or a set of solutions that is able to process and index digital multi-media database in a cost effective, scalable, and automatic fashion. Though such efforts in tackling certain parts of the solution have been made, but due to a variety of reason, none has proved to be completely satisfactory. One reason is that digital video recognition research has been at its infancy stage; secondly, open standard technology has only been developed sufficient to allow system neutral, device neutral, format neutral platforms; thirdly the concerned industries have not embraced the interactive media until very recently; fourthly, no system has fully realized the cutting edge technology research development; fifthly no system has integrated the needs of the enterprises and to tailor its design according to main types of media contents from heavily produced contents of news, entertainment, education and training materials to home video, web cam, webcasting, and to different content applications and service applications; sixthly, on going research in academic and industry labs are often without concerns or even much knowledge of the industry needs; and last, any vision that relies on unlimited computing power and connection bandwidth may provide a total solution, but not realistic for the foreseeable future.

To give a few examples of Prior Arts: First in systems concerning new media. Ref. 1 focused on news video story parsing based on well-defined temporal structures in news video. Repetitive patterns of anchor appearance in news video was detected using simple motion analysis based on predefined anchor shot templates and was used as indication of news story boundaries. However, only image data were used in this proposed scheme, and only minimum content-based browsing can be done with such a scheme. Ref. 2 uses key-frames and text information to provide pictorial transcript of news video, with almost no automatic structural and content analysis. In Ref. 3 speech and image analysis were combined to extract content information and to build indexes of news video. Recently, more research efforts adopted the idea of information fusion such that image, audio and speech analysis are integrated in video content analysis [e.g. Ref. 4, & Ref. 5]. Combination of audio and video content technologies are used in Ref. 6, creating an impressive system for content-based news video recording and browsing, but the functionalities are limited, and the focus was mainly for home users.

Entertainment contents, such as movies, TV programs, music videos, and educational and training videos have ways to interact with viewers and users (this invention and its related application uses the term viewser) different from news contents Entertainment contents, such as movies, TV programs, music videos, and educational and training videos have ways to interact with viewers and users (this invention and its related application uses the term viewser) different from news contents. Comparing to news video, these areas are even less development. In the following sections, prior arts will be referred to in the footnotes as their relevance shown in the description of the invention.

The following references teach elements of the present invention or are part of the relevant background thereof:
Ref. 1 H.-J. Zhang, Y.-H. Gong, S. W. Smoliar and S. Y. Tan. Automatic parsing of news video. Proc. of the IEEE International Conference on Multimedia Computing and Systems, 1994. pp. 45-54.
Ref. 2 B. Shahraray and D. Gibbon, “Automatic authoring of hypermedia documents of video programs,” Proc. of ACM Multimedia '95, San Francisco, November 1995, pp.401-409.
Ref. 3 A. G. Hauptmann and M. Smith, “Text, Speech and Vision for Video Segmentation: The Informedia Project”, Working Notes of IJCAI Workshop on Intelligent Multimedia Information Retrieval, Montreal, August 1995, pp.17-22.
Ref. 4 J. S. Boreczky and L. D. Wilcox. A Hidden Markov Model Frame Work for Video Segmentation Using Audio and Image Features. Proceedings of ICASSP '98, pp.3741-3744, Seattle, May 1998.
Ref. 5 T. Zhang and C.-C. J. Kuo. Video Content Parsing Based on Combined Audio and Visual Information. SPIE 1999, Vol. IV, pp. 78-89.
Ref. 6H. Jiang, H.-J. Zhang, Audio content analysis in video structure analysis, Technical Report, Microsoft Research, China.
Ref. 7 Francis Ng, Boon-Lock Yeo, Minerva Yeung, “Improving MPEG43DMC Geometry Coding Using DPCM Techniques,” ISO/IEC JTC/SC29/WG11 (Coding of Moving Pictures and Associated Audio) M4719, July 1999.
Ref. 8 Wactlar HD, Kanade T, Smith MA, Stevens SM (1996) Intel-ligent access to digital video: The Informedia project. IEEE Computer 29: 46-52
Ref. 9 Smith MA, Kanade T (1997) Video skimming and characterization through the combination of image and language understanding technique. Proceedings of IEEE Conference on Computer Vision and Pattern Recognition, Puerto Rico, pp. 775-781
Ref. 10 Lienhart R, Stuber F (1996) Automatic text recognition in digital videos. Proceedings of SPIE Image and Video Processing IV 2666: 180-188
Ref. 11 Kurakake S, Kuwano H, Odaka K (1997) Recognition and visual feature matching of text region in video for conceptual indexing. Proceedings of SPIE Storage and Retrieval in Image and Video Databases 3022: 368-379
Ref. 12 Cui Y, Huang Q (1997) Character extraction of license plates from video. Proceedings of IEEE Conference on Computer Vision and Pattern Recognition, Puerto Rico, pp. 502-507
Ref. 13 Ohya J, Shio A, Akamatsu S (1994) Recognizing characters in scene images. IEEE Trans Pattern Analysis and Machine Intelligence 16: 214-220
Ref. 14 Zhou J, Lopresti D, Lei Z (1997) OCR for World Wide Web images. Proceedings of SPIE Document Recognition IV 3027: 58-66
Ref. 15 Wu V, Manmatha R, Riseman EM (1997) Finding text in images. Proceedings of the second ACM International Conference on Digital Libraries, Philadelphia, Pa., ACM Press, New York, N.Y., pp. 3-12
Ref. 16 Brunelli R, Poggio T (1997) Template matching: Matched spatiallters and beyond. Pattern Recognition 30: 751-768
Ref. 17 Lu Y (1995) Machine printed character segmentation—an overview. Pattern Recognition 28: 67-80
Ref. 18 Lee SW, Lee DJ, Park HS (1996) A new methodology for gray scale character segmentation and recognition.IEEE Trans Pattern Analysis and Machine Intelligence 18: 1045-1050
Ref. 19 Information Science Research Institute (1994) 1994 annual research report. Also, Doc 2 in AOL download
Ref. 20X.-R. Chen and H.-J. Zhang, Text Area Detection From Video Frames, Technical Report, Microsoft Research, China.
Ref. 21 S. T. Dumais, J. Platt, D. Heckerman and M. Sahami Inductive learning algorithms and representations for text categorization. Proc. of ACM-CIKM98.
Ref. 22 G. Hager and P. Belhumeur. Efficient regions tracking with parametric models of geometry and illumination. IEEE Trans. on Pattern Analysis and Machine Intelligence, October 1998.
Ref. 23 Y. Bar-Shalom and X. Li. Estimation and Tracking: principles, techniques and software. Yaakov Bar-Shalom (YBS), Storrs, CT, 1998.
Ref. 24 J. R Bergen, P Anandan, Keith J Hanna, and Rajesh Hingorani. Hierarchical model-based motion estimation. In G Sandini, editor, Eur. Conf on Computer Vision (ECCV). Springer-Verlag, 1992.
Ref. 25 Frank Dellaert, Chuck Thorpe, and Sebastian Thrun. Super-resolved tracking of planar surface patches. In IEEE/RSJ Intl. Conf on Intelligent Robots and Systems (IROS), 1998.
Ref. 26 Frank Dellaert, Sebastian Thrun, and Chuck Thorpe. Jacobian images of super-resolved texture maps for model-based motion estimation and tracking. In IEEE Workshop on Applications of Computer Vision (WACV), 1998.
Ref. 27 G. D. Hager and P. N. Belhumeur. Real time tracking of image regions with changes in geometry and illumination. In IEEE Conf on Computer Vision and Pattern Recognition (CVPR), pages 403-410, 1996.
Ref. 28 T. Kanade, R. Collins, A. Lipton, P. Burt, and L. Wixson. Advances in cooperative multi-sensor video surveillance. In DARPA Image Understanding Workshop (IUW), pages 3-24, 1998.
Ref. 29 R. Kumar, P. Anandan, M. Irani, J. Bergen, and K. Hanna. Representation of scenes from collections of images. In Representation of Visual Scenes, 1995.
Ref. 30 A. Lipton, H. Fujiyosh, and R. Patil. Moving target classification and tracking from real time video. In IEEE Workshop on Applications of Computer Vision (WACV), pages 8-14, 1998.
Ref. 31 S. J. Reeves. Selection of observations in magnetic resonance spectroscopic imaging.
Ref. 32 P. Rosin and T. Ellis. Image difference threshold strategies and shadow detection. In British Machine Vision Conference (BMVC), pages 347-356, 1995.
Ref. 33H.-Y. Shum and R. Szeliski. Construction and refinement of panoramic mosaics with global and local alignment. In Intl. Conf on Computer Vision (ICCV), pages 953-958, Bombay, January 1998.
Ref. 34 C. Stauffer and W. E. L. Grimson. Adaptive background mixture models for real-time tracking. In IEEE Conf on Computer Vision and Pattern Recognition (CVPR), volume 2, pages 246-252, 1999.

### SUMMARY OF THE INVENTION

This invention put forward a new system design of multimedia recognition, processing, and indexing. 1. It utilizes several new researches and technologies in multi-media processing; 2. It anticipates the completion in a year of several multi-media processing technologies now being fostered; 3. It takes thorough considerations of technologies being used in video security surveillance, media post-production, digital video storage and management, military visual and tacking technologies, and how these technologies can be better applied in the context of this system design; 4. It makes unique integration of these existing, new, and upcoming technologies with a number of other off-the-shelf technologies that have not been used in this combined fashion before (such as OCR, speech recognition, audio transcription, cross-indexing, etc.), therefore providing new usage and applications beyond the simple sum of the functions of each technology; 5. It arranges these technologies as components in a system that is open standard, and therefore can improve itself by modifying and replacing the technology components; 6. It targets specifically heavily produced media contents from news, entertainment, and education and training; 7. It makes suggestions as to how media contents can be produced in the future that will allow post-production, storage, processing and indexing to make much more efficient use of this system.

Other features and advantages of the present invention will become apparent from the following more detailed description, taken in conjunction with the accompanying drawings, which illustrate, by way of example, the principles of the invention.

### BRIEF DESCRIPTION OF THE DRAWING FIGURES

FIG. 1 shows the overall flow of the system.

FIG. 2 shows the processing mechanism of Text MMRP, Audio MMRP, and the STR part of Video MMRP.

FIG. 3 shows the processing mechanism of the Indexing for Retrieval (IFT).

FIG. 4 shows the processing mechanism of the Video MMRP.

### DETAILED DESCRIPTION OF THE INVENTION

The above described drawing figures illustrate the invention in at least one of its preferred embodiments, which is further defined in detail in the following description.

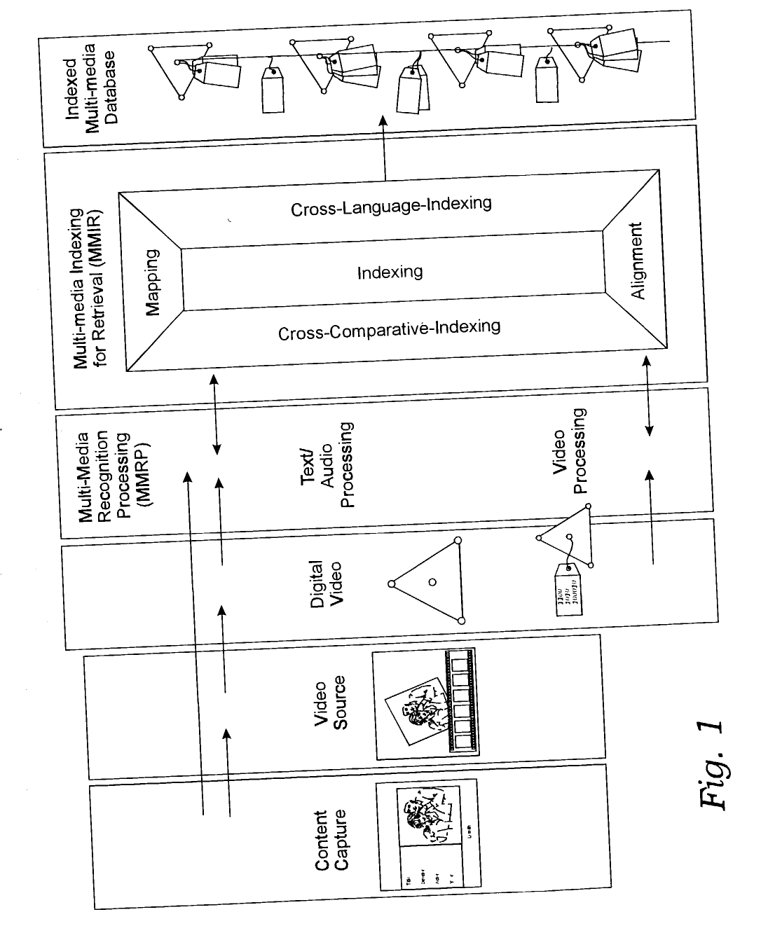

This invention consists of a middleware platform, and technology components. There is also a separate section at the end suggesting a preferred multimedia content production process to better utilize the system. In the following sections, technology components (I), the open standard platform (II) and the media production recommendations (III) will be each described. In technology components, there are two functional areas: multi-media recognition and processing (MMRP), and indexing for retrieval (IFR). See FIG. 1.

FIG. 1 The process starts from content capturing on the left, then to videos sources that will be digitized. The digital video streams into the platform of Multi-Media Recognition and Processing (MMRP) functional area, and Indexing for Retrial (IFR) functional area including CCI, alignment, mapping, and cross-language indexing. The MMRP and IFR have 2 way interaction, MMRP processed video multimedia elements will be processed in IFT, while certain index information will be guiding the further MMRP processing of concerned digital video clips. Eventually, video database is tagged (segmented) into the final products—indexed multimedia Database to the right.

The video database is segmented into smaller clips based on various requirements through the functional areas of the platform. Contextual packets generated by the processing and indexing functions will be inserted between the clips. The packet itself could be video clip from other sources. The function of packets (clips) include links, hyper links, bookmarks, user data, statistics, hot spot, moving spot/area/activation method, activity, updates, requests, etc. The tag shape represents all kinds of packets.

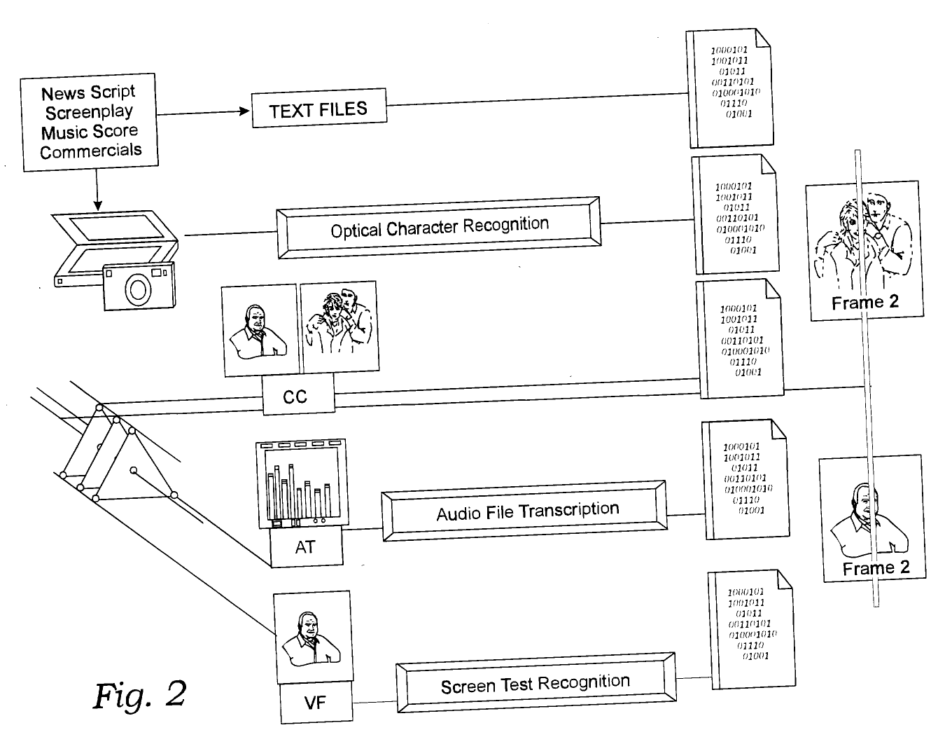

FIG. 2 The digital files generated Text MMRP, Audio MMRP, and the STR part of Video MMRP are all text. The while lines show text files from program scripts, they are either in digital forms already (top line), or through scanner and OCR processing (2^{nd} line). The Green line is the close caption tracking of the video clip, in digital text format already. Pink line represents the audio tracks. Through AFT, it generates digital text information about the clip. Red line is the video image, those images that have on screen text will be processed through STR and generate digital text information. The original video database clip (on the left side) becomes as many as five categories of digital text files along with the video frames (on the right side) that will be further process in the Video MMRP, all stamped by TC (the yellow line).

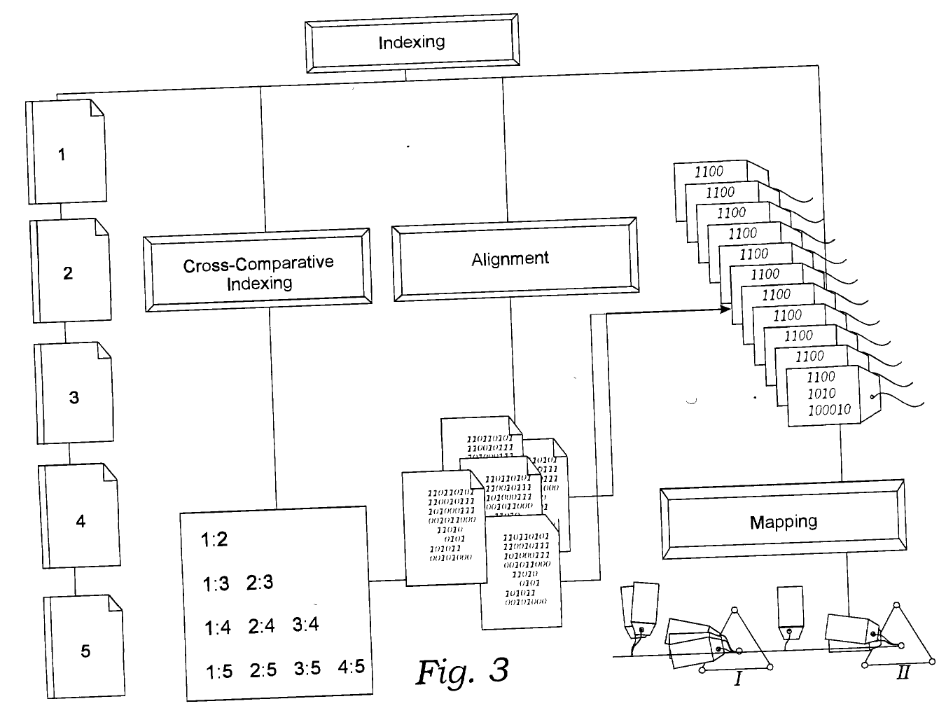

FIG. 3 Digital text files are cross-compared through CCI, and aligned where related text information will align to each other. All these text information will be mapped onto the TC, where certain information are tagged onto the represented clips, while others tags wail be between the 2 frames selected to show in the figure, or outside the clip areas of the 2 selected frames. Using an example from a movie clip, text file generated from AFT will have dialogues between characters, and silence or noise in between that AFT would to be able to generate meaningful information. Then text file from the original movie script either generated from print version through scanner and OCR, or directly from its original digital format will show what is going on in the scene between the dialogues, be it a scenery, car chase, or generic street scene. The audio transcription text file, extensive information from original script are compared and aligned wherever the two shows the same identifiable dialogue. Since most of the sources of text file, especially close caption and audio file transcripts, are TC stamped, these compared, and aligned files be mapped fairly accurately to the time code.

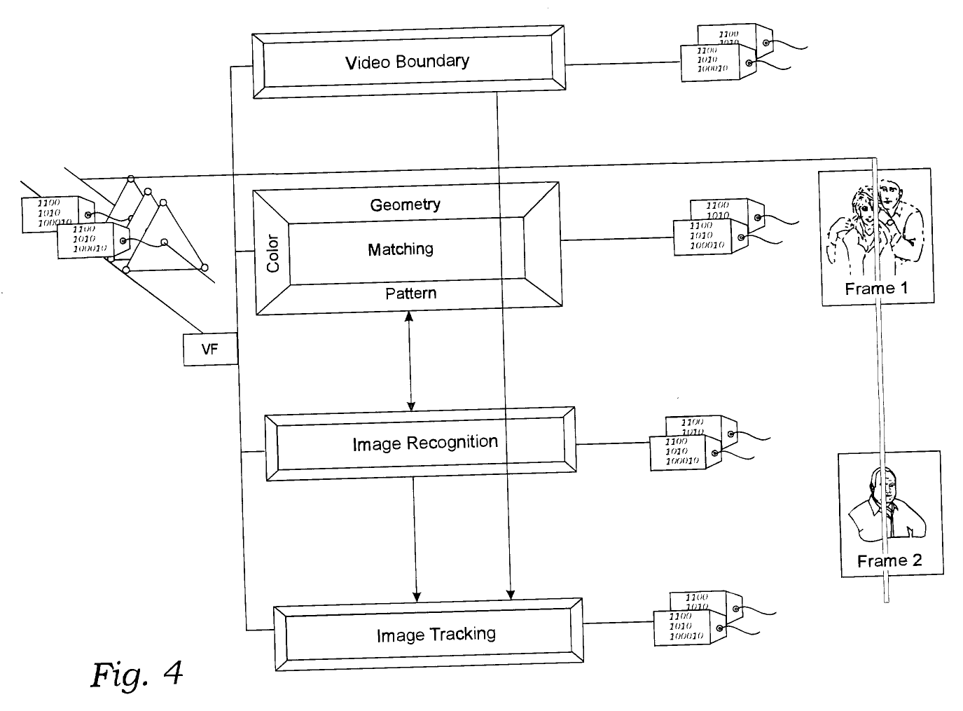

FIG. 4 In Video MMRP, video frames (the red line) are processed through VB, CGPM, IR, and IT. Shot boundaries such as camera angles are identified through VB, which becomes a basic tag for higher level processing. Using color, geometric shapes, and pattern through CGPM, more basic tags are generated about the VF. Based on CGPM, a higher-level Video MMRP—IR is performed where key images are identified, and some of these key images will be tracked through consecutive frames through IT.

I. Technology Components:

In MMRP functional area, major modals of the multimedia database—text, audio, and video, are processed using a number of proprietary, and off-the shelf technologies. They include text data understanding, Optical Character Recognition (OCR), Audio File Transcription (AFT), Screen Text Recognition (STR), Video (or shot) Boundary (VB), Image Recognition (IR), and Image Tracking (IT); in IFR functional area, processing results from MMRP along with related digital text files from close caption, and news script, subtitles, screenplays, music scores, and commercial scripts will be used to cross-compare (in Cross-Comparative Indexing, CCI), aligned, and mapped onto Time Code-stamped multi-media database. Through these components, multi-media database will be segmented according to desired criteria. (See FIG. 2, and FIG. 4)

Text MMRP

In the types of media contents this system is primarily concerned with, i.e. heavily produced media contents, most, if not all video materials have fairly extensive text information. A movie has a movie script, so is news; musicals and music videos have music score and lyrics; advertisement, sponsorship, and PSAs also have script. Some of these text, especially recent contents are in digital format (call it Text type A). While older contents may have a print version (call it Text Type B). Besides these text files, most of the programs also have Close Caption (CC), and foreign contents often have subtitles. CC is also in digital form, while some subtitles are in digital form (Subtitle Type A), others maybe superimposed onto the screen (subtitle Type B). Text Type B can be transformed into digital form through OCR, a fairly mature area of technology. Subtitle Type B can also be transformed into digital format through a kind of video OCR—Screen Text Recognition (STR), which will be described more in details later.

Text understanding is a mature area of computer science. Using the video material related text would enable small amount computing to index the video materials to a fairly high degree before a less developed area of computer science—video processing is introduced into the process.

Audio MMRP

Sound tracks in the concerned contents also provide vital information about the video contents. Using speech recognition FFT, audio tracks can be understood by computer. Using Audio File Transcription (AFT)technology, the audio files can be used in conjunction with other text files.

Along with CC, audio files are time stamped. These two sources of digital text information about the multi-media database therefore become important guide to other text files for the IFR processes to map all relevant information intelligently and accurately onto the Time Code.

With the Text MMRP, and Audio MMRP, video parsing process are guided through text and audio.

Video MMRP

Screen Text Recognition (STR)

One powerful index for retrieval is the text appearing in them. It enables content-based browsing. STR is a video OCR, a technique that can greatly help to locate topics of interest in a large digital news video archive via the automatic extraction and reading of captions, subtitles, and annotations. News captions, text in movie trailers, and subtitles generally provide vital search information about the video being presented—the names of people, key dialogue, places, and descriptions of objects.

The algorithms this system uses make use of typical characteristics of text in videos in order to enable and enhance segmentation and recognition performance. It involves first the text localization in images and videos, and then a OCR process that understands the located text in the visual in natural language understanding process. Related researches are discussed in Ref. 7-Ref. 21.

Color/Geometry/Pattern Matching (CGPM)

Primary features of video database contain color, geometry, and pattern, etc. Recognizing these features provide the basis for high level image recognition and video processing. The inventor and his associates are developing an algorithm that is faster, more scalable and accurate for color, geometry, and pattern matching. There is a lot of research done in this area, Ref. 22 is one of the examples.

This system employs basic colors such as Red, Blue, Green, Yellow, etc., and basic geometric shapes such as Square, and Circle, and basic patterns such as Stripe, and Check.

Image Recognition (IR)

Based on CGPM, this system uses pre-defined images according to the type of contents being processed. This can be faces such as movie stars, news anchormen, singers, politicians, sports stars, and other news makers; it can also be types of images such as ball players, uniformed characters; or it can be images that will have relevance for adding service applications later on, such as key products shown in the contents, cars, jewelry, books, guns, computers, etc.

Most of the approaches so far in image recognition use Principal Component Analysis (PCA). This approach is data dependent and computationally expensive. To classify unknown images, PCA needs to match the images with nearest neighbor in the stored database of extracted image features. If Discrete Cosine Transforms (DCTs) are used, then the dimensionality of image space is reduced by truncating high frequency DCT components. The remaining coefficients are fed into a neural network for classification. Because only a small number of low frequency DCT components are necessary to preserve the most important image features, such as facial features of hair outline, eyes and mouth, or car features of standard outline, color, reflection, textual scenarios, a DCT-based image recognition system is much faster than other approaches.

Image Tracking (IT)

Tracking images in consecutive frames for key images is very useful in complex visual. For instance, more than one key images processed through IR could appear and their relative positions change, as well as background, sharpness, and topological order. If content applications and service applications are added onto these key images, tracking them would ensure the links added to these images in the visual stay accurate. Being able to track a fast moving object in vague image, and image with complex background are the two key areas of technology this invention is keen on. Relying on cutting edge researches and technologies in video security surveillance, and military visual tracking technologies, this system integrates this vital component into the MMRP. (See Ref. 23-Ref. 34)

Indexing for Retrieval (IFR)

In functional area IFR, processing results from MMRP cross-compare (in Cross-Comparative Indexing, CCI), aligned, and mapped onto Time Code-stamped multi-media database. FIG. 3 gives a clear view of the flow of the IFR.

II. PLATFORM

The invention is open standard, allowing various technology components so far mentioned to be integrated together, and to allow third party developers to customize and improve the platform and its extensions. It is the goal of the invention to allow various expertise, and talents, old and new media perspectives, existing and emerging multi-media indexing technologies being able to participate in the creation of the Converged Interactive Media through intensive indexing of multimedia contents for retrieval. The invention provides the basics for the functional areas of MMRP and IFR to be integrated and flow in a seamless manner; it enables certain functions and invites for endlessly more.

To achieve such a goal, it is necessary to create a system that can be operated among different operating systems, computer languages, hardware platforms, in other words, the interoperatability of distributed applications. Such a middleware system can be developed based on several choices. Among others, OMG's Corba component technology has the highest capacity to be completely neutral among different systems in the market; Sun Micro System's Gini along with Java Space, and Sun's Remote Method Invocation (RMI) based Java Bean are close cousins to Corba; Microsoft's DICOM, though not OS neutral, does provide better performance, and enables plug & play. These choices can all build the system designed here to achieve interoperatability of distributed technology components as well as off the shelf software and hardware—all can be labeled as distributed application objects (DAO).

A middleware platform of DAO provides detailed object management specifications, which serves as a common framework for application development. Conformance to these specifications will make it possible to develop a heterogeneous computing environment across all major hardware platforms and operating systems, and in the case of Corba, all computer languages. Using OMG's Corba as example, it defines object management as software development that models the real world through representation of “objects.” These objects are the encapsulation of the attributes, relationships and methods of software identifiable program components. A key benefit of an object-oriented system is its ability to expand in functionality by extending existing components and adding new objects to the system. Object management results in faster application development, easier maintenance, enormous scalability and reusable software.

The invention's platform builds a configuration called a component directory (CD). Multimedia data stream in and through the platform, and a CD manager oversees the connection of these components and controls the stream's data flow. Applications control the CD's activities by communicating with the CD manager.

The two basic types of objects used in the architecture are components and entries. A component is a Corba object that performs a specific task, such VB, STR, IR, etc. For each stream it handles, it exposes at least one entry. An entry is a Corba object created by the component that represents a point of connection for a unidirectional data stream on the component. Input entries accept data into the component, and output entries provide data to other components. A source component provides one output entry for each stream of data in the file. A typical transform component, such as a compression/decompression (codec) component, provides one input entry and one output entry, while an audio output component typically exposes only one input entry. More complex arrangements are also possible. Entries are responsible for providing interfaces to connect with other entries and for transporting the data. The entry interfaces support the following: 1. The transfer of TC-stamped data using shared memory or other resource; 2. Negotiation of data formats at each entry-to-entry connection; 3. Buffer management and buffer allocation negotiation designed to minimize data copying and maximize throughput. Entry interfaces differ slightly, depending on whether they are output entries or input entries.

Entry methods are called to allow the entry to be queried for entering, connecting, and data type information, and to send flush notifications downstream when the CD stops. The renderer passes the media position information upstream to the component responsible for queuing the stream to the appropriate position.

III. Preferfed Multimedia Content Production

As previous sections have shown, the type of content to provide has a close relationship to the technologies that will be employed. The central role of this step is to transfer the multi-media (raw footage) into digital format so that it can be used in later steps. All the procedures in the normal Production will have an impact on the final deliverable content. The preferred production process is a natural integration of various modules involved in this process. From the content creation point of view, it normally has four major parts: 1.) Conceptualization, 2.) Video production, 3.) Postproduction, and 4.) Scripting.

1.) The conceptualization (planning) phase requires authors to consider the production's overall (large-scale) structure. This includes the story, play, cast, their relationship (interests) with viewsers, commercials, possible feedbacks, and marketing issues. Most of these related issues will be dealt with in the following steps. However, a thorough understanding and planning of all the potential parties and actions that will be involved helps to create a dynamic structure that can be deployed efficiently later on.

Under the new general Production Preparation framework and storyboarding unit, authors conceptualize the narrative's link structure as well as many related multimedia data prior to actual video production, such as related web site, prior gathered information, viewer feedbacks, etc. It will embody sufficient details about the video scenes, narrative sequences, related actions (within different video footage and related informational sources) and opportunities to produce a shooting script for the next phase. It will also generate the basic database structure, which will be used to store the Meta data information about the production and information and relationship with various other media data types. It provides multimedia authors a model that accommodates partial specifications and interactive multimedia scenarios.

2.) Video production phase requires the authors to map the production script onto the process of linear (traditional) production and interaction mapping. Simple time-line model lacks the flexibility to represent relations that are determined interactively, such as at runtime. The new representation for asynchronous and synchronous temporal events lets authors creates scenarios offering viewsers non-halting, transparent options. The usual array of specialists is needed to produce the video footage, such as crew for video, sound, and lighting, as well as actors and a director. Some scenes might need two or more cameras to capture the action from multiple perspectives, such as long-shots, close-ups, or reaction shots, which will be used together with other media data to create the dynamic, interactive linking mechanism. It includes a time-based reference between video scenes, where a specific time in the source video can trigger (if activated) the playback of the destination video scene Specific filler sequences (sometimes related commercials) could be shot and played in loops to fill the dead ends and holes in the narratives and normal informational display which coexist in the viewing window. During a video production, camera techniques can produce navigational bridges between some scenes without breaking the cinematic aesthetics. Especially for interactive online assembled video shots from various links, to fill the hole and to append smooth transitions, novel computer generated graphics and imagery can be applied to merge or synthesize new frames, which will be blended into real video footage in real-time. The technique will be largely image-based, with little human intervention, and pre-programmed type of reactions can be stored for efficiency.

3.) During the post-production and video editing stage, the raw video footage will be edited and captured in digital form. Related media data as well as interaction mechanism will be integrated into the media stream as well. Postproduction lets authors find ways of incorporating alternate takes or camera perspectives of the same scenes as well. Once edited, the video will be transcribed and cataloged for later organization into a multi-threaded video database for nonlinear searching and access.

4.) The production and development environment meets crucial requirements, provides synchronous control of audio, video, and textual media resources with a high-level scripting interface. The script can specify the spatial and temporal placement of text, annotation, web links, video links, and video clips on the screen. It generates a loop back (feedback) mechanism so that the scene script can change with time as more people have watched it and provided feedback or interactions. The XML markup language can be used to code the content so that it can be dynamically modified in the future.

While the invention has been described with reference to at least one preferred embodiment, it is to be clearly understood by those skilled in the art that the invention is not limited thereto. Rather, the scope of the invention is to be interpreted only in conjunction with the appended claims.

1. A multimedia application method comprising the steps of: capturing analog source video programs and converting the analog source video programs into digital video programs; transforming the digital video programs into selected formats; defining modality sets of the digital video programs as tracks of audio, text, still images, moving images, and image objects in video frames; using selected techniques for parallel processing the modality sets; generating tags of the modality sets and storing the tags as metadata; comparing and cross-referencing the tags, thereby defining relevance and interrelationships between the tags thereby mirroring the interrelationships of the modality sets; thematically relating clips of the tags; enabling addition, subtraction, combining and division of the modality sets; establishing numerical correspondence between the parallel processes and the modality sets; cross-comparing and cross-referencing the metadata.
